(19) United States
(12) Patent Application Publication
(10) Pub. No.: US 2024/0384941 A1
(43) Pub. Date: Nov. 21, 2024

(54) STEAM ACCUMULATION MULTILAYER RESERVOIR WITH APPLICATION OF PHASE CHANGE MATERIAL

(71) Applicants: Alexander Levin, Binyamina (IL); Hanan-Emanuel Levin, Binyamina (IL)

(72) Inventors: Alexander Levin, Binyamina (IL); Hanan-Emanuel Levin, Binyamina (IL)

(21) Appl. No.: 18/320,248

(22) Filed: May 19, 2023

(51) Int. Cl. F28D 20/02

(52) U.S. Cl. CPC F28D 20/023; F01K 1/04

(57) ABSTRACT

An invention proposes a novel steam accumulator, which is designed as a multilayer reservoir with application of phase change materials (PCM) for alternative steam condensation—condensate's evaporation in cycles of periodic charging-discharging such steam accumulator.

PCM is contained in sealed impermeable packs, which are placed vertically on metal trays; the metal trays are arranged in a multilayer form in a thermo-insulated reservoir.

Fabric or wire netting components, serving as wicks, ensure nearly complete wetting of the sealed packs' exterior surfaces by the condensate during its evaporation, facilitated by the melted PCM within the packs.

### BACKGROUND OF THE INVENTION

This invention relates to the area of heat management equipment, more specifically, to steam accumulators or Ruths accumulators.

A steam accumulator is an insulated steel pressure tank containing hot water and steam under pressure. It can be used to smooth out peaks and troughs in demand for steam. Steam accumulators may take on a significance for energy storage in solar thermal power plants, i.e., they can store thermal energy as sensible heat of water during hours of intensive solar radiation with release of this heat as discharged saturated steam during hours with weak solar radiation or at nighttime.

The tank of heat storage is about half-filled with cold water and steam is blown in from a boiler via a perforated pipe near the bottom of the tank. Some of the steam condenses and heats the water. The remainder fills the space above the water level. When the steam accumulator is fully charged the condensed steam will have raised the water level in the tank to about three-quarters full and the temperature and pressure will also have risen.

In the stage of discharge, that is, in the stage of consumption of stored steam, pressure in the tank is gradually reduced and saturated steam with gradually reduced temperature and pressure is discharged from the tank.

It should be noted, that phase-change storage allows achieving high energy density with resulting economical advantage. Design of a phase-change storage container must provide appropriate technical solutions to problems of poor heat transfer of a phase-change material (PCM), corrosion, possible chemical reaction between the PCM and a heat transfer fluid (HTF), possible change of the PCM volume in the process of the phase change.

Technology of micro- and macro-encapsulation is widely used in the modern practice in order to solve these problems.

However, this technology is very expensive and resulting specific cost of stored thermal energy is usually high.

There are some patents and articles related to the area of steam storage with application of PCM.

An article: J. Buschle, W. D. Steinmann, R. Tamme LATENT HEAT STORAGE FOR PROCESS HEAT APPLICATION, 10th International Conference on thermal Energy Storage ECOSTOCK 2006 describes application of PCM for steam accumulation.

ES patent No. 2765855T3 describes a steam accumulator, which provides process steam for an industrial process, where the steam accumulator comprises a storage container and at least one first latent heat accumulator with a transition temperature of first phase, where the storage container comprises a storage space containing a liquid and vapor (10), where the at least one first latent heat accumulator is designed as a chamber filled with a phase change material, where the first latent heat accumulator comprises a first heat transfer surface and at least on the first heat transfer surface is in indirect thermal contact with the storage space, where the at least one first latent heat accumulator comprises a heating device, characterized in that the heating device is completely arranged in at least one first accumulator of latent heat and the at least one first latent heat accumulator can heat the heating device independently of a heat transfer on the first heat transfer surface.

Patent DE 102011121471 A1 describes a steam accumulator, which is filled with a loose filling of PCM capsules. This loose fill is penetrated by a heat transfer fluid. The heat exchangers are arranged in the steam accumulator in such a way that the filling of the PCM capsules surrounds the heat exchangers.

U.S. Pat. No. 4,696,338 discloses a heat storage and transfer system and method in which a liquid-solid phase change material and a liquid-vapor phase change material selected for coaction with each other are disposed in a container with a body of the liquid phase of the liquid-vapor material in continuous contact with a body of the liquid phase of the liquid-solid material for superior heat transfer between the materials for giving up and transferring sensible heat and liquid to solid phase change latent heat to vaporize liquid-vapor phase change material and vapor to liquid phase change latent heat to a condenser/heat exchanger and also for superior heat transfer from a heat source such as a solar or electric heater by giving up the heat of condensation of a vapor phase to a solid-liquid material which accepts the heat as sensible heat and as heat of melting.

ES2870918T3 to inventors of Axiotherm company describes a macro-encapsulated PCM module shaped as an oblate disk.

It should be noted that the patents described above, which are related to steam accumulators with application of PCM, have two drawbacks.
1. They are costly regarding a unit of stored steam.
2. Large scaling of these steam accumulators causes low ratio values of their surfaces of heat exchange and free surfaces of water evaporation in the stage of steam discharging to the volume of accumulated steam in the form of condensate. It causes, in turn, to diminishment values of specific steam generation per volume of a steam accumulator itself.

### BRIEF SUMMARY OF THE INVENTION

This invention proposes a steam accumulator with application of PCM that is designed as a thermo-insulated tank with a multilayer bank (or banks) of metal trays, wherein each metal tray comprises a set of ceramic or metal carcasses and each metal carcass comprises, in turn, some parallel oblate sealed metal impermeable packs, which are fabricated preferable from thin metal foil, laminated foil, laminated fiberglass cloth or polymer film, with filing these sealed impermeable packs with PCM (phase change material).

PCM can contain a filler to improve thermal conductivity, another filler comprising a nucleating agent, or a combination thereof.

These metal sealed impermeable packs are hung directly or indirectly on crossbars, which are supported on their outer sections by the recesses of the ceramic or metal carcass with a certain gap between neighboring sealed impermeable packs.

In one version with direct hanging of the sealed impermeable packs; each sealed impermeable pack is joined at its upper edge with a crossbar, when the outside sections of this crossbar are protruded somewhat from the contour of the sealed impermeable pack.

It provides the possibility to hang the sealed impermeable pack in the ceramic or metal carcass.

The skirt of the metal tray is significantly higher than the vertical dimension of the sealed metal impermeable packs.

In such a way, there is a free space between the bottom of the metal tray and lower edges of the sealed impermeable packs.

Each sealed impermeable pack is provided by a member of capillary fabric or wire netting, which serves as a wick and covers most of the fraction of the external surface of the sealed impermeable pack from both its sides, wherein the lower section of this fabric or wire netting member is significantly lower, then the lower edge of the sealed impermeable pack and has the capability to elevate entire amount of condensate obtained from steam by complete melting of PCM contained in this sealed impermeable pack.

There are two main versions of designing the fabric or wire netting member. In a first version, there are fabric or wire netting sleeves, which cover the sealed impermeable packs. The perimeter of a transversal cross-section of each fabric or wire netting sleeve is significantly larger than the perimeter of a corresponding cross-section of the sealed impermeable pack. This perimeter of the fabric or wire netting sleeve is chosen in such manner that the lower section of the fabric or wire netting sleeve, which is arranged on the sealed impermeable pack, is in contact or very nearly to the bottom of the metal tray.

The material of the fabric or wire netting sleeves has capillary structure with the ability to soak water against gravity by wetting the complete or almost complete external surface of the sealed impermeable pack, which is in contact with this fabric or wire netting sleeve.

In a second version, the fabric or wire netting member is realized as a fabric or wire netting plate, which is shaped as an overturned U; this fabric or wire netting plate covers mostly both external sides of a sealed impermeable pack and its lower sections extend significantly lower than the position of the lower edge of the sealed impermeable pack,

There is a possibility of indirectly joining the sealed impermeable pack with a crossbar that serves to hang this sealed impermeable pack together with its fabric or wire netting member, on the upper edges of a rigid structure placed on the metal tray or on the upper edge of the tray's skirt itself.

In this design a fabric or wire netting member can be provided with two horizontal seams at its upper and lower sections, which form an upper internal through space and a middle internal through space.

The perimeter of a transversal cross-section of this upper internal space fits the transversal perimeter of the crossbar, and the perimeter of the internal middle section fits the perimeter of a transversal cross-section of the sealed impermeable pack.

In such a way, the crossbar can be placed in this upper internal through space with its outer sections protruded regarding the fabric or wire netting member, and the sealed impermeable pack is placed in the middle internal through space.

It excludes necessity of joining the crossbars with the upper edges of the sealed impermeable packs.

In order to provide intimate contact of the fabric or wire netting members with the corresponding sealed impermeable packs the entire volume of the metal tray is filled, after installation of the sealed impermeable packs with their fabric or wire netting members and their rigid structures, with pebble or coarse sand.

It is right for both versions of the fabric or wire netting member described above.

In such a way, pebbles or coarse sand serve as spacers between the sealed impermeable packs (including their fabric or wire netting members) and between the sealed impermeable packs and the skirt of the metal tray, and on the other hand, pebbles or coarse sand ensure intimate contact between the fabric or wire netting members and the external walls of the sealed impermeable packs.

The fabric or wire netting members, serve as wicks for completely wetting the external walls of the sealed impermeable packs, with the condensate collected on the trays' bottoms.

The external surfaces of the sealed impermeable packs can be covered with porous capillary coatings or can be provided with hydrophilic coatings in order to achieve complete wetting of these external surfaces.

There is reciprocation motion of condensate on the fabric or wire netting members: downwards at a charging stage and upwards at a discharging stage.

The fabric members are fabricated from thermostable mineral fabric.

The metal trays are arranged in multilayer manner in the internal space of the thermo-insulated tank; in such a way, there are gaps between the skirts of the metal trays and the internal wall of the thermo-insulated tank.

These gaps provide passage of steam along the internal wall of the thermo-insulated tank.

The thermo-insulated tank is provided with inlet and outlet connections for charging and discharging steam in and out of the internal space of the thermo-insulated tank, and with an outlet connection at its lower section at a level between the bottom of the thermo-insulated tank and the bottom of the lowest metal tray for periodic discharging condensate obtained by condensation of steam on the internal surface of the thermo-insulated tank.

The inlet and outlet connections are communicated to appropriate valves.

In addition, the charging and discharging valves are communicated with corresponding inlet and outlet connections via flowmeters, which indicate of the completion of charging and discharging stages.

The lower section of the thermo-insulated tank is provided with a level gauge installed at a level between the bottom of the lowest metal tray and the bottom of the thermo-insulated tank itself.

This level gauge indicates a moment for drainage of condensate collected on the bottom of the thermo-insulated tank.

In addition, the steam accumulation reservoir can be provided with a manometer.

Each metal tray is provided with supporting legs at its lower section, which partially protrude outside and partially inside relative to the contour of the metal tray.

In an additional version of this invention, a metal tray is provided with a flange, which serves for the installation of a set of parallel horizontal crossbars from U-profiles, where each U-profile on its vertical shelves is provided with recesses for positioning the outside sections of the crossbars of the sealed impermeable packs with PCM described previously.

There is a gap between the outer edge of the flange and the internal wall of the thermo-insulated housing.

As in the first version, height of the skirt of the metal tray is higher than vertical dimension of the sealed impermeable packs; and there are fabric or wire netting members, which cover the sealed impermeable packs. Perimeter of a transversal cross-section of each fabric or wire netting member is significantly larger than perimeter of a corresponding cross-section of the sealed impermeable pack.

The internal space of the metal tray with its sealed impermeable packs is filled with pebble or coarse sand.

As in the first version, a portion of the tray's volume of the space between the tray's bottom and the lower edges of the sealed impermeable packs can collect a significant portion of the total amount of condensate obtained by condensation of steam at the expense of latent melting heat of PCM contained in the sealed impermeable packs of the tray.

In a third version of this invention, open boxes made of ceramics or metal are used instead of ceramic or metal carcasses.

Two opposite upper edges of each open box are provided with recesses serving for positioning the outside sections of the crossbars of the sealed impermeable packs with PCM and with their fabric or wire netting members as it was described previously.

Height of each open box is higher than vertical dimension of the sealed impermeable packs, and there are fabric or wire netting members, which cover the sealed impermeable packs. Perimeter or length of a transversal cross-section of each fabric or wire netting member is significantly larger than perimeter of a corresponding cross-section of the sealed impermeable pack.

The internal space of each open box with its sealed impermeable packs is filled with pebble or coarse sand.

In such a way, the internal space of the open box, which is located between its bottom and the lower edges of the sealed impermeable packs, can collect a most fraction of condensate obtained by condensation of steam at the expense of latent melting heat of PCM contained in the sealed impermeable packs.

The open boxes maybe fabricated from metal, common ceramics, fire clay, glass, glass ceramics, fibro-reinforced concrete or glass-fiber reinforced concrete.

The fabric or wire netting members serve as wicks for wetting the external walls of the sealed impermeable packs by condensate collected on the bottoms of the open boxes.

In a fourth version of this invention, metal trays have a rectangular shape. Each metal tray is provided with two metal strips, which are placed inside the metal tray near its two opposite walls. Each metal strip forms a periodic longitudinal structure with three types of sections:
the upper sections, which serve for placing of lower sections of sealed impermeable packs with PCM, wherein this PCM is in its solid state and the sealed impermeable pack are mostly covered by fabric or wire netting members; the lower sections, which are supported by the bottom of the metal tray; two extreme sections, which serve for engagement with two other opposite tray's walls.

In addition, it is possible to apply auxiliary metal strips, which are shaped like the metal strips described above and placed between two opposite walls of the metal tray intermediately.

It should be noted that the installed sealed impermeable packs are arranged with certain gaps regarding the bottom of the metal tray and the lower sections of their fabric or wire netting members are situated lower, near the bottom of the metal tray.

There are gaps between each pair of neighboring sealed impermeable packs (the sealed impermeable packs have longitudinal shape with a length that fits the width of the metal tray).

After the installation of all sealed impermeable packs in the metal tray, its free space is filled with pebble or coarse sand, which ensures preservation of the required shape of the sealed impermeable packs for liquid state of the PCM contained in them.

In this way, pebbles or coarse sand play the role of holding elements in the arrangement of the sealed impermeable packs in the metal tray.

The sealed impermeable packs, which are preferably fabricated from metal foil, can be sealed by welding, brazing, soldering or folding.

The sealed impermeable packs, which are fabricated from laminated metal foil or high temperature resistant polymer film, can be sealed by welding.

### BRIEF DESCRIPTION OF THE SEVERAL VIEWS OF THE DRAWING

FIGS. 1a and FIG. 1b show two versions of a transversal cross-section of a sealed impermeable pack with a crossbar joined with its upper edge, wherein this sealed impermeable pack is covered with a fabric or wire netting sleeve (FIG. 1a) or a fabric or wire netting plate shaped as an overturned U (FIG. 1b).

FIG. 1c and FIG. 1d show two versions of the transversal cross-section of the sealed impermeable pack with a crossbar inserted into an upper internal through space obtained by a horizontal seam at the upper section of the fabric or wire netting sleeve and the sealed impermeable pack, which is inserted into a middle internal through space formed in the fabric or wire netting sleeve between the horizontal seam at the upper section of the fabric or wire netting sleeve and a horizontal seam of the fabric or wire netting sleeve at its lower section (FIG. 1c); or a fabric or wire netting plate shaped as an overturned U with a crossbar inserted into an upper internal through space obtained by a horizontal seam at the upper section of the fabric or wire netting plate; and the sealed impermeable pack, which is inserted into a middle internal through space formed in the fabric or wire netting plate between the horizontal seam at the upper section of the fabric or wire netting plate and a horizontal seam of the fabric or wire netting plate at its lower section (FIG. 1d).

FIG. 2a and FIG. 2b are a vertical cross-section and a view from above of a ceramic rectangular carcass, which comprises four vertical walls; the upper edges of two opposite vertical walls are provided with sets of recesses.

FIG. 2c is the vertical cross-section of the ceramic rectangular carcass, which comprises four vertical walls; the upper edges of two opposite vertical walls are provided with the sets of the recesses, and there are sealed impermeable packs containing PCM; the upper edges of these sealed impermeable packs are joined with crossbars with outside sections, which are protruded outwards regarding the contours of the sealed impermeable packs and these outside sections are arranged in the recesses of the ceramic rectangular carcass.

In addition, the sealed impermeable packs are covered with fabric or wire netting sleeves.

FIG. 3a is a view from above of a metal carcass shaped as a parallelepiped with two auxiliary angles installed on two opposite upper edges of the metal carcass; the vertical shelves of these angles are provided with sets of recesses.

FIG. 3b is a vertical cross-section of the metal carcass shaped as the parallelepiped with two auxiliary angles installed on two opposite upper edges of the metal carcass; the vertical shelves of these angles are provided with sets of recesses.

FIG. 3c is a vertical cross-section of the metal carcass shaped as the parallelepiped with two auxiliary angles installed on two opposite upper edges of the metal carcass; the vertical shelves of these auxiliary angles are provided with sets of recesses, and there are sealed impermeable packs containing PCM; the upper edges of these sealed impermeable packs are joined with crossbars with outside sections, which are protruded outwards regarding the contours of the sealed impermeable packs and these outside sections are arranged in the recesses of the auxiliary angles.

In addition, the sealed impermeable packs are covered with fabric or wire netting sleeves.

FIG. 4a and FIG. 4b are a vertical cross-section and a view from above of a ceramic rectangular box, which comprises four vertical walls and a bottom; the upper edges of two opposite vertical walls are provided with sets of recesses.

FIG. 4c is a vertical cross-section of the ceramic rectangular box, which comprises four vertical walls and the bottom; the upper edges of two opposite vertical walls are provided with the sets of the recesses, and there are sealed impermeable packs containing PCM; the upper edges of these sealed impermeable packs are joined with crossbars with outside sections, which are protruded outwards regarding the contours of the sealed impermeable packs, and these outside sections are arranged in the recesses of the ceramic rectangular box.

In addition, the sealed impermeable packs are covered with fabric or wire netting sleeves.

The rest free space of the ceramic rectangular box is filled with pebble or coarse sand.

The crossbar is inserted into the upper internal through space with its outer sections protruded from the contour of the fabric or wire netting sleeve.

These outer sections are positioned in the recesses of two opposite edges of the open box.

The sealed impermeable pack is placed in the middle internal trough space.

The remaining free space of the ceramic rectangular box is filled with pebble or coarse sand.

FIG. 5a is a view from above of a metal tray shaped as a rectangular box with some horizontal auxiliary U-profiles installed on flange of the metal tray; the vertical shelves of these horizontal U-profiles are provided with sets of recesses.

FIG. 5b is a vertical cross-section of the metal tray shaped as the rectangular box with some auxiliary horizontal U-profiles installed on the flange of the metal tray; the vertical shelves of these horizontal angle profiles are provided with sets of recesses.

FIG. 5c is the vertical cross-section of the metal tray shaped as the rectangular box with some auxiliary horizontal U-profiles installed on flange of the metal tray; the vertical shelves of these auxiliary horizontal U-profiles are provided with the sets of the recesses, and there are sealed impermeable packs containing PCM; the upper edges of these sealed impermeable packs are joined with crossbars with outside sections, which are protruded outwards regarding the contours of the sealed impermeable packs and these outside sections are arranged in the recesses of the auxiliary horizontal U-profiles.

In addition, the sealed impermeable packs are covered with fabric or wire netting sleeves.

The rest free space of the metal tray is filled with pebble or coarse sand.

FIG. 6a and FIG. 6b show a view from above and a vertical cross-section of a rectangular metal tray with two metal strips, which are installed near two opposite walls of the rectangular metal tray and formed as a longitudinal structure with: multiple upper sections serving for positioning lower extreme sections of longitudinal sealed impermeable packs; multiple lower sections being supported by the bottom of the rectangular metal tray; two extreme sections serving for engagement with two other opposite walls of the rectangular metal tray.

FIG. 6c shows a vertical cross-section of a rectangular metal tray with two metal strips as it is shown in FIG. 6b, wherein a bank of longitudinal sealed impermeable packs is established with their extreme sections on the upper sections of two metal strips; these longitudinal sealed impermeable packs are filled with PCM and covered mostly with fabric or wire netting members; the length or the perimeter of each fabric or wire netting member is larger than the perimeter of a vertical cross-section of the longitudinal sealed impermeable pack (this vertical cross-section is perpendicular regarding the longitudinal direction of the longitudinal sealed impermeable pack).

The remaining free space in the rectangular metal tray is filled with pebble.

FIG. 7 shows a vertical cross-section of a steam accumulator shaped as a reservoir with an arrangement of multilayer metal trays, which are provided with sealed impermeable packs containing PCM (as each of them is presented in FIG. 5c).

### DETAILED DESCRIPTION OF THE INVENTION

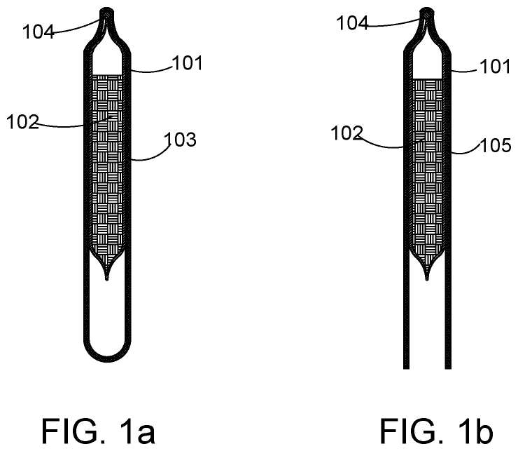

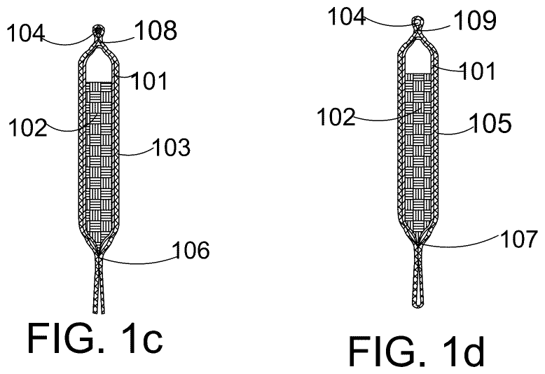

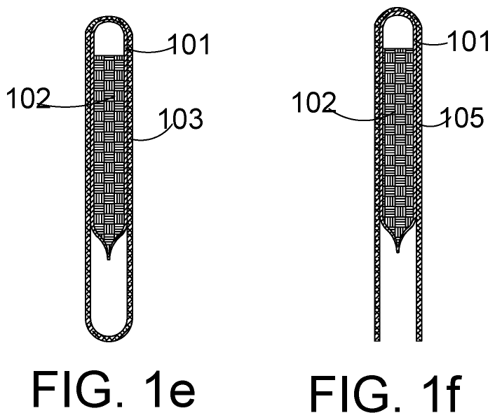

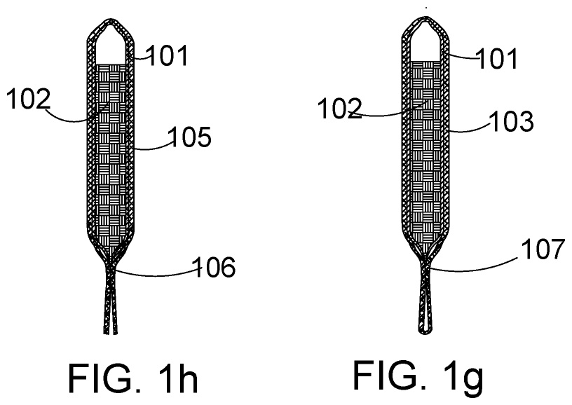

FIG. 1a, FIG. 1b, FIG. 1c and FIG. 1d show various versions of transversal cross-sections of a sealed impermeable pack, which is filled with PCM and covered by a fabric or wire netting member.

FIG. 1a shows-a sealed impermeable pack 101 with PCM 102, which fills partially the internal space of the sealed impermeable pack 101; crossbar 104 joined with the upper edge of the sealed impermeable pack 101; a fabric or wire netting sleeve 103, which covers a most fraction of the external surface of the sealed impermeable pack 101 and crossbar 104.

FIG. 1b shows the sealed impermeable pack 101 with PCM 102, which partially fills the internal space of the sealed impermeable pack 101; crossbar 104 joined with the upper edge of the sealed impermeable pack 101; a fabric or wire netting plate 105, which covers most fractions of the external surface of the sealed impermeable pack 101 and crossbar 104; this fabric or wire netting plate 105 is shaped as overturned U.

FIG. 1c and FIG. 1d show two versions of the transversal cross-section of the sealed impermeable pack with a crossbar inserted into an upper internal through space obtained by a horizontal seam at the upper section of the fabric or wire netting sleeve; and the sealed impermeable pack, which is inserted into a middle internal through space formed in the fabric or wire netting sleeve between the horizontal seam at the upper section of the fabric or wire netting sleeve and a horizontal seam of the fabric or wire netting sleeve at its lower section (FIG. 1c); or a fabric or wire netting plate shaped as an overturned U with a crossbar inserted into an upper internal through space obtained by a horizontal seam at the upper section of the fabric or wire netting plate; and the sealed impermeable pack, which is inserted into a middle internal through space formed in the fabric or wire netting plate between the horizontal seam at the upper section of the fabric or wire netting plate and a horizontal seam of the fabric or wire netting plate at its lower section (FIG. 1d).

FIG. 1c shows-a sealed impermeable pack 101 with PCM 102, which partially fills the internal space of the sealed impermeable pack 101; crossbar 104 joined with the upper edge of the sealed impermeable pack 101; a fabric or wire netting sleeve 103, which covers most fractions of the external surface of the sealed impermeable pack 101 and crossbar 104. The fabric or wire netting sleeve 103 is provided with a lower horizontal seam 106 and an upper horizontal seam 108.

FIG. 1d shows the sealed impermeable pack 101 with PCM 102, which partially fills the internal space of the sealed impermeable pack 101; crossbar 104 joined with the upper edge of the sealed impermeable pack 101; a fabric or wire netting plate 105, which covers most fractions of the external surface of the sealed impermeable pack 101 and crossbar 104; this fabric or wire netting plate 105 is shaped as overturned U.

The fabric or wire netting plate 105 is provided with a lower horizontal seam 107 and an upper horizontal seam 109.

FIG. 1e, FIG. 1g, FIG. 1f and FIG. 1h show some versions of transversal cross-sections of a sealed impermeable pack, which are analogous to FIG. 1a, FIG. 1b, FIG. 1c and FIG. 1d, however, without application of crossbars joined with the upper edges of the flexible impermeable packs with PCM.

FIG. 1e shows-a sealed impermeable pack 101 with PCM 102, which partially fills the internal space of the sealed impermeable pack 101; a fabric or wire netting sleeve 103, which covers most fraction of the external surface of the sealed impermeable pack.

FIG. 1f shows a sealed impermeable pack 101 with PCM 102, which partially fills the internal space of the sealed impermeable pack 101; a fabric or wire netting sleeve 103, which covers most fraction of the external surface of the sealed impermeable pack 101.

FIG. 1g shows the sealed impermeable pack 101 with PCM 102, which partially fills the internal space of the sealed impermeable pack 101; a fabric or wire netting plate 105, which covers most fractions of the external surface of the sealed impermeable pack 101; this fabric or wire netting plate 105 is shaped as an overturned U.

The fabric or wire netting sleeve 103 is provided with the lower horizontal seam 106.

FIG. 1g shows the sealed impermeable pack 101 with PCM 102, which fills partially the internal space of the sealed impermeable pack 101; a fabric or wire netting plate 105, which covers a most fractions of the external surface of the sealed impermeable pack 101; this fabric or wire netting plate 105 is shaped as overturned U.

FIG. 1h shows the sealed impermeable pack 101 with PCM 102, which partially fills the internal space of the sealed impermeable pack 101; a fabric or wire netting plate 105, which covers most fractions of the external surface of the sealed impermeable pack 101 and crossbar 104; this fabric or wire netting plate 105 is shaped as an overturned U.

The fabric or wire netting plate 105 is provided with the lower horizontal seam 107.

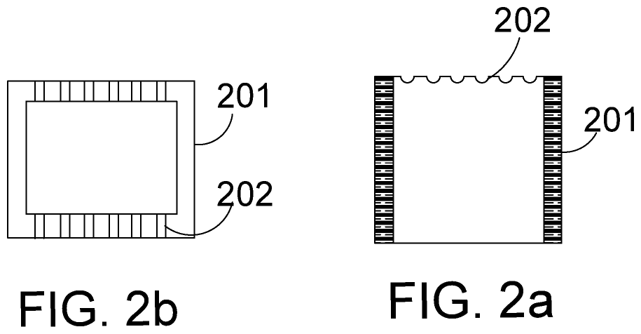

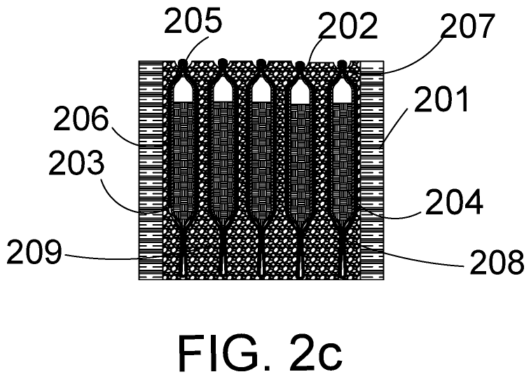

FIG. 2a and FIG. 2b are a vertical cross-section and a view from above of a ceramic rectangular carcass, which comprises four vertical walls; the upper edges of two opposite vertical walls are provided with sets of recesses.

These drawings comprise: the vertical walls 201 of the ceramic rectangular with recesses 202 at two opposite upper edges of the vertical walls 201.

FIG. 2c is the vertical cross-section of the ceramic rectangular carcass, which comprises four vertical walls; the upper edges of two opposite vertical walls are provided with the sets of the recesses, and there are sealed impermeable packs containing PCM; the upper edges of these sealed impermeable packs are supported by crossbars with outside sections, which are protruded outwards regarding the contours of the sealed impermeable packs and these outside sections are arranged in the recesses of the ceramic rectangular carcass.

In addition, the sealed impermeable packs are covered with a fabric or wire netting sleeves.

This drawing comprises: the vertical walls 201 of the ceramic rectangular carcass with recesses 202 at its upper edges; the sealed impermeable packs 203, which contain PCM 204 and are supported by crossbars 205 in combination with fabric or wire netting sleeves 206, which cover the sealed impermeable packs 203 and are provided with upper and lower horizontal seams 207 and 208; pebble filling 209 controls buckling phenomena of the sealed impermeable packs 203 with molten PCM 204 under hydraulic pressure.

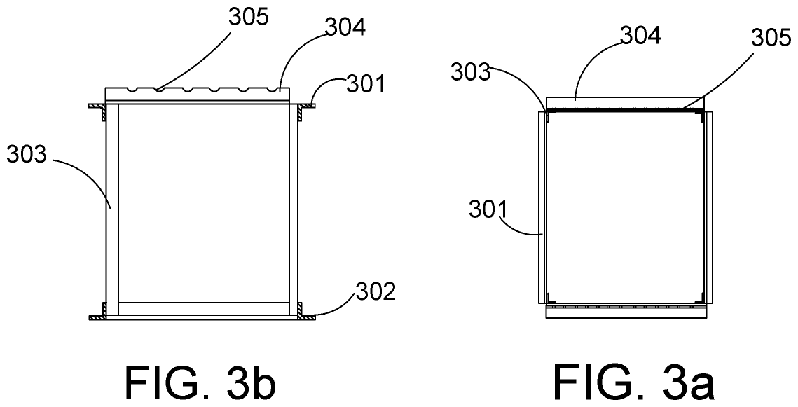

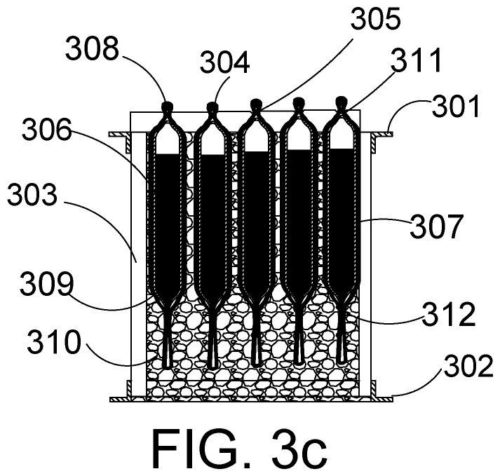

FIG. 3a is a view from above of a metal carcass shaped as a parallelepiped with two auxiliary angles installed on two opposite upper edges of the metal carcass; the vertical shelves of these angles are provided with sets of recesses.

This drawing shows upper angles 301, vertical angles 303; two auxiliary angles 304 installed on two opposite upper angles 301 of the metal carcass; the vertical shelves of these auxiliary angles 304 are provided with sets of recesses 305.

FIG. 3b is a vertical cross-section of the metal carcass shaped as the parallelepiped with two auxiliary angles installed on two opposite upper edges of the metal carcass; the vertical shelves of these angles are provided with sets of recesses.

This drawing shows the upper angles 301, the lower angles 302; the vertical angles 303; two auxiliary angles 304 installed on two opposite upper angles 301 of the metal carcass; the vertical shelves of these auxiliary angles 304 are provided with recesses 305.

FIG. 3c is the vertical cross-section of the metal carcass shaped as the parallelepiped with two auxiliary angles installed on two opposite upper edges of the metal carcass; the vertical shelves of these angles are provided with recesses, and there are sealed impermeable packs containing PCM; crossbars with outside sections, which are protruded outwards regarding the contours of the sealed impermeable packs and these outside sections are arranged in the recesses of the angles.

In addition, the sealed impermeable packs are covered with a fabric or wire netting sleeves.

This drawing shows: the upper angles 301; the lower angles 302; the vertical angles 303; two auxiliary angles 304 installed on two opposite upper angles 301 of the metal carcass; the vertical shelves of these auxiliary angles 304 are provided with recesses 305; sealed impermeable packs 306 with PCM 307; these sealed impermeable packs 306 are supported by crossbars 308 in combination with fabric or wire netting sleeves 309, which cover the sealed impermeable packs 306 and are provided with upper and lower horizontal seams 311 and 312; pebble or coarse sand filling 310, which control buckling phenomena of the sealed impermeable packs 306 with molten PCM 307 under hydraulic pressure.

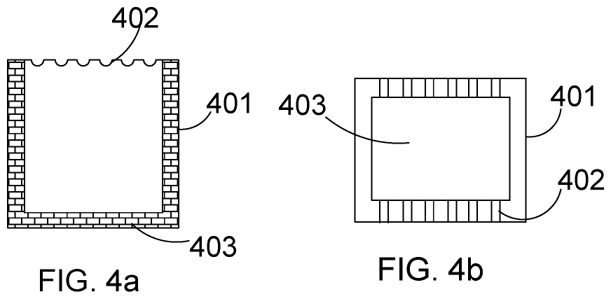

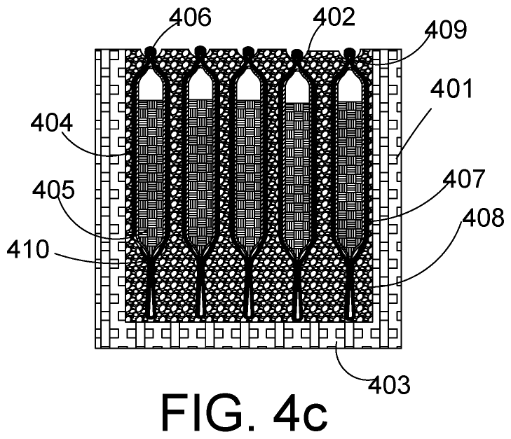

FIG. 4a and FIG. 4b are a vertical cross-section and a view from above of a ceramic rectangular box, which comprises four vertical walls and a bottom; the upper edges of two opposite vertical walls are provided with recesses.

These drawings show: the vertical walls 401 of the ceramic rectangular box with recesses 402 on the upper edges of two opposite walls 401; a bottom plate 403.

FIG. 4c is the vertical cross-section of the ceramic rectangular box, which comprises four vertical walls and the bottom; the upper edges of two opposite vertical walls are provided with the recesses, and there are sealed impermeable packs containing PCM; crossbars with outside sections, which are protruded outwards regarding the contours of the sealed impermeable packs and these outside sections are placed in the recesses of the ceramic rectangular box.

In addition, the sealed impermeable packs are covered with fabric or wire netting sleeves.

The rest free space of the ceramic rectangular box is filled with pebble or coarse sand.

This drawing shows: the vertical walls 401 of the ceramic rectangular box with recesses 402 on the upper edges of two opposite walls 401; a bottom plate 403; sealed impermeable packs 404 with PCM 405; these sealed impermeable packs 404 are supported by crossbars 406 in combination with fabric or wire netting sleeves 407, which cover the sealed impermeable packs 404 and are provided with upper and lower horizontal seams 409 and 410; the outer sections of crossbars 406 are positioned in recesses 402; pebble or coarse sand filling 408, which control buckling phenomena of the sealed impermeable packs 404 with molten PCM 405 under hydraulic pressure.

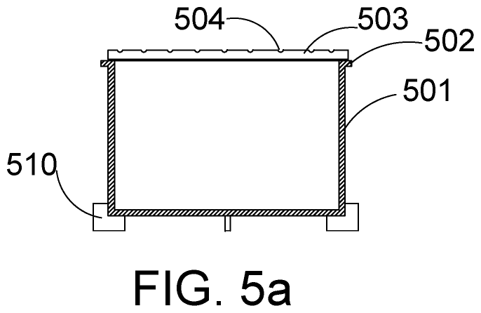

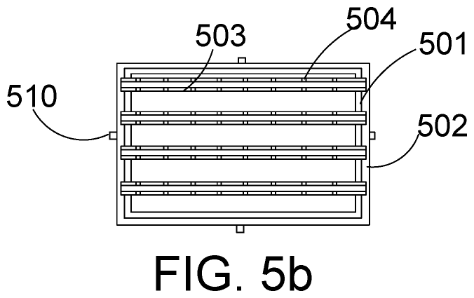

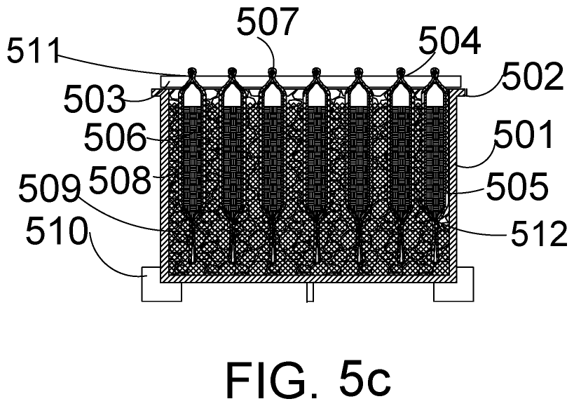

FIG. 5a is a view from above of a metal tray shaped as a rectangular box with some horizontal auxiliary U-profiles installed on a flange of the metal tray; the vertical shelves of these horizontal U-profiles are provided with recesses.

The drawing FIG. 5a shows: the metal tray 501 with flange 502, supporting legs 510 and the set of the horizontal U-profiles 503 with recesses 504.

FIG. 5b is a vertical cross-section of the metal tray shaped as the rectangular box with some auxiliary horizontal U-profiles installed on the flange of the metal tray; the vertical shelves of these horizontal angle profiles are provided with recesses.

The drawing shows: the metal tray 501 with flange 502, the supporting legs 510 and the set of the horizontal U-profiles 503 with recesses 504.

FIG. 5c is the vertical cross-section of the metal tray shaped as the rectangular box with some auxiliary horizontal U-profiles installed on the flange of the metal tray; the vertical shelves of these horizontal U-profiles are provided of the recesses, and there are sealed impermeable packs containing PCM; these sealed impermeable packs are supported by crossbars with outside sections, which are protruded outwards regarding the contours of the sealed impermeable packs and these outside sections are arranged in the recesses of the U-profiles.

In addition, the sealed impermeable packs are covered with fabric or wire netting sleeves.

The rest free space of the metal tray is filled with pebble or coarse sand.

The drawing shows: the metal tray 501 with flange 502 and the set of the horizontal U-profiles 503 with recesses 504; sealed impermeable packs 505 with PCM 506; these sealed impermeable packs 505 are supported by crossbars 507 in combination with fabric or wire netting sleeves 508, which cover the sealed impermeable packs 505 and are provided with upper and lower horizontal seams 511 and 512; pebble or coarse sand filling 509, which control buckling phenomena of the sealed impermeable packs 505 with molten PCM 506 under hydraulic pressure.

In addition, the metal tray is provided with legs 510.

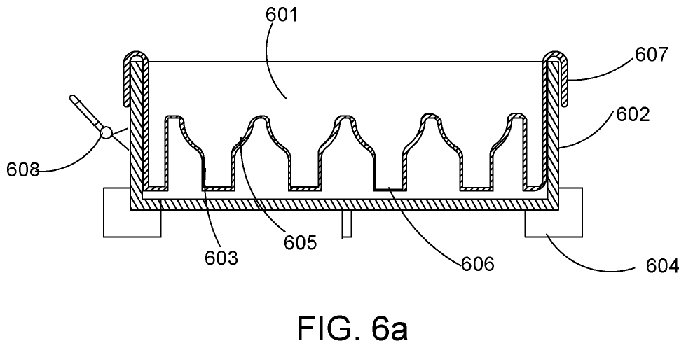

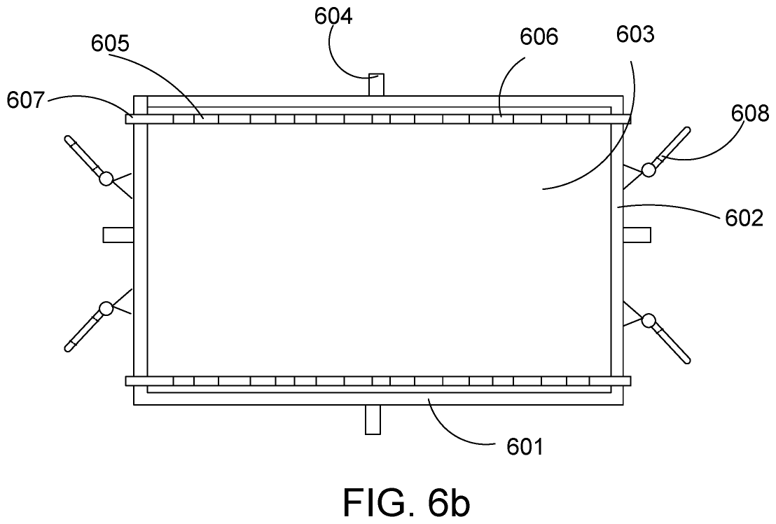

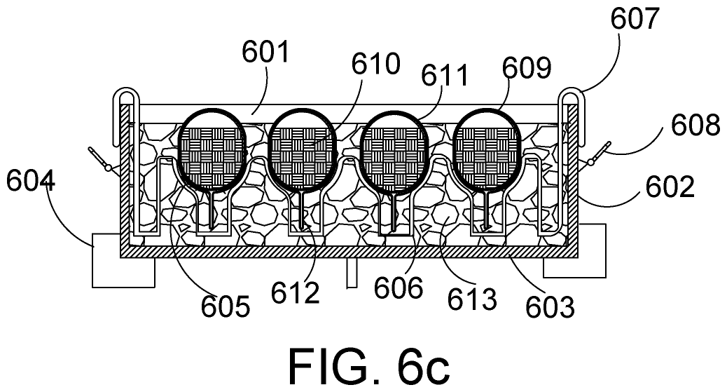

FIG. 6a and FIG. 6b show a view from above and a vertical cross-section of a rectangular metal tray with two metal strips, which are installed near two opposite walls of the rectangular metal tray and formed as a longitudinal structure with: multiple upper sections serving for positioning lower extreme sections of longitudinal sealed impermeable packs; multiple lower sections being supported by the bottom of the rectangular metal tray; two extreme sections serving for engagement with two other opposite walls of the rectangular metal tray.

These drawings show: a rectangular metal tray with a pair of opposite lateral walls 601 and another pair of opposite lateral walls 602; a bottom plate 603; supporting legs 604.

Two metal strips, which are placed near two opposite walls 601 in the internal space of the rectangular metal tray form periodic longitudinal structures, which comprises: upper supporting sections 605 intended to support lower extreme sections of longitudinal sealed impermeable packs; lower sections 606 supported by bottom plate 603 and two extreme sections 607 engaged with two opposite walls 602.

Four eyes 608 are joined externally with the opposite walls 602.

FIG. 6c shows a vertical cross-section of the rectangular metal tray with two metal strips as it is shown in FIG. 6b, wherein a bank of longitudinal sealed impermeable packs is established with their extreme sections on the upper sections of two metal strips; these longitudinal sealed impermeable packs are filled with PCM and covered mostly with fabric or wire netting members; the length or perimeter of each fabric or wire netting member is larger than the perimeter of a vertical cross-section of the longitudinal sealed impermeable pack (this vertical cross-section is perpendicular regarding the longitudinal direction of the longitudinal sealed impermeable pack).

The rest free space in the rectangular metal tray is filled with pebble.

This drawing shows following elements: the rectangular metal tray with the pair of the opposite lateral walls 602; the bottom plate 603; the supporting legs 604.

Two metal strips, which are placed near two opposite walls 601 in the internal space of the rectangular metal tray form periodic longitudinal structures, which comprises: the upper supporting sections 605 intended to support lower extreme sections of longitudinal sealed impermeable packs; the lower sections 606 supported by the bottom plate 603 and two extreme sections 607 engaged with two opposite walls 602.

Four eyes 608 are joined externally with the opposite walls 602.

There is plurality of sealed impermeable packs 609, which are filled with PCM 610 and covered at least partially with fabric or wire netting sleeves 611 comprising, in turn, lower sections 612 intended for soaking condensate from the bottom section of the metal tray.

The lower extreme sections of the sealed impermeable packs 609 are supported by the upper supporting sections 605 of the metal strips.

The free space of the metal tray is filled with pebble 613.

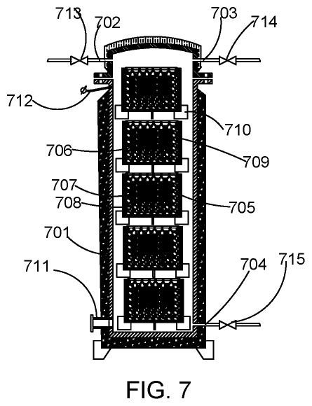

FIG. 7 shows a vertical cross-section of a steam accumulator shaped as a reservoir with an arrangement of multilayer metal trays, which are provided with sealed impermeable packs containing PCM (as each of them is presented in FIG. 5c).

The drawing in FIG. 7 comprises: a thermo-insulated housing 701 with inlet and outlet connections 702 and 703 and a lower outlet connection 704 for drainage of condensate collected on the bottom section of the thermo-insulated housing; 701; a multilayer bank of metal trays 705 with supporting legs 710 and with the sealed impermeable packs 706 filled with PCM 707; fabric or wire netting sleeves 708; pebble filling 709.

The thermo-insulated housing 701 is provided with a level gauge 711 situated at its lower section and manometer 712.

In addition, there are valves 713, 714 and 715 installed on lines communicated with the inlet connection 702 and the outlet connections 703 and 704.

1. A steam accumulation multilayer tower with the capability of periodic condensation of the supplied steam, accumulating the received condensate, and its subsequent evaporation with the generation of steam accompanied by steam discharging; said steam accumulation multitower comprising:
a thermo-insulated housing provided with steam inlet and steam outlet connections for feeding and withdrawal of steam in/out of said steam accumulation multilayer tower and with a condensate outlet connection at its lower section for drainage of condensate collected on the bottom of said thermo-insulated housing; each said inlet or outlet connection is communicated with a valve for periodic supply or withdrawal of steam or condensate in/out of said thermo-insulated housing;
a multilayer arrangement of metal trays in said thermo-insulated housing; each said metal tray has a bottom and a skirt, wherein each said metal tray has a gap between its skirt and the internal wall of said thermo-insulated housing; each said metal tray is provided with heat charging/discharging modules with the following elements:
ceramic or metal carcasses; each said ceramic or metal carcass is shaped as a parallelepiped with four vertical walls with two sets of recesses at their two opposite upper edges; a set of sealed flexible packs having an oblate form and they are filled up at least partially with phase change material (PCM); each said sealed flexible pack is joined at its upper edge with a crossbar and the outside sections of said crossbar somewhat protrude from the contour of said sealed flexible pack; said sealed flexible packs are arranged vertically in said ceramic or metal rectangular carcass with a certain gap between two said neighboring sealed flexible packs, wherein the outer sections of said crossbars are positioned in said recesses; the vertical size of said skirt is larger than the height of said sealed flexible pack; so there is a certain distance between the lower edges of said sealed flexible packs and the bottom of said metal tray; the internal volume of said metal tray between said lower edges of said sealed flexible packs and said bottom of said metal tray can collect most of the condensate obtained and collected in said metal tray by complete melting of said PCM in said sealed flexible packs of all heat charging/discharging modules arranged in said metal tray;
each sealed flexible pack is covered by a fabric sleeve; the perimeter of a transversal cross-section of each said fabric sleeve is significantly larger than the perimeter of a corresponding cross-section of said sealed flexible pack and this perimeter of said fabric sleeve is chosen in such manner that the lower section of said fabric sleeve arranged on said sealed flexible pack is in contact with or very nearly to said bottom of said metal tray;
the free space of each said metal tray, including the internal free space of its heat charging/discharging modules is filled up with pebbles; each said metal tray is provided with supporting legs at its lower section and with upward protruding members on its skirt with openings in said protruding members;
the lower section of said thermo-insulated housing is provided with a level gauge.

2. The steam accumulation multilayer tower as claimed in claim 1, wherein the PCM in the sealed flexible packs is provided with filler for improving thermal conductivity or with filler comprising a nucleating agent, or a combination thereof.

3. The steam accumulation multilayer tower as claimed in claim 1, wherein the thermo-insulated housing is provided with a manometer.

4. The steam accumulation multilayer tower as claimed in claim 1, wherein the inlet and outlet connections for supply and withdrawal steam in/out the thermo-insulated housing are in fluid communication with flowmeters.

5. The steam accumulation multilayer tower as claimed in claim 1, wherein the external surfaces of the sealed flexible packs are covered with porous capillary coatings or with hydrophilic coatings.

6. A steam accumulation multilayer tower with the capability of periodic condensation of the supplied steam, accumulating the received condensate, and its subsequent evaporation with the generation of steam accompanied by steam discharging; said steam accumulation multitower comprising:
a thermo-insulated housing provided with steam inlet and steam outlet connections for feeding and withdrawal of steam in/out said steam accumulation multilayer tower and with a condensate outlet connection at its lower section for drainage of condensate collected on the bottom of said thermo-insulated housing; each said inlet or outlet connection is communicated with a valve for periodic supply or withdrawal of steam or condensate in/out of said thermo-insulated housing;
a multilayer arrangement of metal trays in said thermo-insulated housing; each said metal tray has a bottom and a skirt, wherein each said metal tray has a gap between its skirt and the internal wall of said thermo-insulated housing; each said metal tray is provided with heat charging/discharging modules with following elements:
ceramic or metal open boxes; each said ceramic or metal open box is shaped as a parallelepiped with four vertical walls, a bottom and with two sets of recesses at their two opposite upper edges;
a set of sealed flexible packs having an oblate form and which are filled up at least partially with phase change material (PCM); each said sealed flexible pack is joined at its upper edge with a crossbar and the outside sections of said crossbar somewhat protruded from the contour of said sealed flexible pack; said sealed flexible packs are arranged vertically in said ceramic or metal open box with a certain gap between two said neighboring sealed flexible packs, wherein the outer sections of said crossbars are positioned in said recesses; the vertical size of said ceramic or metal open box is larger than the height of said sealed flexible pack; so there is a certain distance between the lower edges of said sealed flexible packs and the bottom of said ceramic or metal open box; the internal volume of said ceramic or metal open box between said lower edges of said sealed flexible packs and said bottom of said ceramic or metal open box can collect the most of the condensate obtained and collected in said ceramic or metal open box by complete melting said PCM in said sealed flexible packs arranged in said ceramic or metal open box;
each sealed flexible pack is covered by a fabric sleeve; perimeter of a transversal cross-section of each said fabric sleeve is significantly larger than perimeter of a corresponding cross-section of said sealed flexible pack and this perimeter of said fabric sleeve is chosen in such manner that the lower section of said fabric sleeve arranged on said sealed flexible pack is in contact or very nearly to said bottom of said ceramic or metal open box;
the free space of each said ceramic or metal open box is filled up by pebbles;
each said metal tray is provided with supporting legs at its lower section and with upward protruding members on its skirt with openings in said protruding members;
the lower section of said thermo-insulated housing is provided with a level gauge.

7. The steam accumulation multilayer tower as claimed in claim 6, wherein the PCM in the sealed flexible packs is provided with filler for improving thermal conductivity or with filler comprising a nucleating agent, or combination thereof.

8. The steam accumulation multilayer tower as claimed in claim 6, wherein the thermo-insulated housing is provided with a manometer.

9. The steam accumulation multilayer tower as claimed in claim 6, wherein the inlet and outlet connections for supply and withdrawal steam in/out the thermo-insulated housing are in fluid communication with flowmeters.

10. The steam accumulation multilayer tower as claimed in claim 6, wherein the external surfaces of the sealed flexible packs are covered with porous capillary coatings or with hydrophilic coatings.

11. A steam accumulation multilayer tower with the capability of periodic condensation of the supplied steam, accumulating the received condensate, and its subsequent evaporation with the generation of steam accompanied by steam discharging; said steam accumulation multitower comprising:
a thermo-insulated housing provided with steam inlet and steam outlet connections for feeding and withdrawal of steam in/out said steam accumulation multilayer tower and with a condensate outlet connection at its lower section for drainage of condensate collected on the bottom of said thermo-insulated housing; each said inlet or outlet connection is communicated with a valve for periodic supply or withdrawal steam or condensate in/out said thermo-insulated housing;
a multilayer arrangement of metal trays in said thermo-insulated housing; each said metal tray has a bottom, a skirt, and a flange, wherein each said metal tray has a gap between its skirt and the internal wall of said thermo-insulated housing; each said metal tray is provided with a set of U-profiles installed on its flange; said U-profiles are provided with recesses at their vertical shelves;
a set of sealed flexible packs having an oblate form and they are filled up at least partially with phase change material (PCM); each said sealed flexible pack is joined at is upper edge with a crossbar and the outside sections of said crossbar somewhat protruded from the contour of said sealed flexible pack; said sealed flexible packs are arranged vertically in said metal tray with a certain gap between two said neighboring sealed flexible packs, wherein the outer sections of said crossbars are positioned in said recesses of said U-profiles; the vertical size of said skirt is larger than the height of said sealed vertical pack; so there is a certain distance between the lower edges of said sealed flexible packs and the bottom of said metal tray; the internal volume between said lower edges of said sealed flexible packs and said bottom of said metal tray can collect most of the condensate obtained and collected in said metal tray by complete melting said PCM in said sealed flexible packs arranged in said metal tray;
each sealed flexible pack is covered by a fabric sleeve; perimeter of a transversal cross-section of each said fabric sleeve is significantly larger than perimeter of a corresponding cross-section of said sealed flexible pack and this perimeter of said fabric sleeve is chosen in such manner that the lower section of said fabric sleeve arranged on said sealed flexible pack is in contact or very nearly to said bottom of said metal tray;
the free space of each said metal tray including is filled up by pebbles;
each said metal tray is provided with supporting legs at its lower section and with upward protruding members on its skirt with openings in said protruding members;
the lower section of said thermo-insulated housing is provided with a level gauge.

12. The steam accumulation multilayer tower as claimed in claim 11, wherein the PCM in the sealed flexible packs is provided with filler for improving thermal conductivity or with filler comprising a nucleating agent, or a combination thereof.

13. The steam accumulation multilayer tower as claimed in claim 11, wherein the thermo-insulated housing is provided with a manometer.

14. The steam accumulation multilayer tower as claimed in claim 11, wherein the inlet and outlet connections for supply and withdrawal of steam in/out of the thermo-insulated housing are in fluid communication with flowmeters.

15. The steam accumulation multilayer tower as claimed in claim 1, wherein the external surfaces of the sealed flexible are covered with porous capillary coatings or with hydrophilic coatings.
